(19) United States
(12) Patent Application Publication
(10) Pub. No.: US 2021/0342802 A1
(43) Pub. Date: Nov. 4, 2021

(54) SYSTEMS AND METHODS FOR OPTIMIZED INVOICE SETTLEMENT

(71) Applicant: Wells Fargo Bank, N.A., San Francisco, CA (US)

(72) Inventors: Matthew Joseph Heffron, Bishop, GA (US); Donald E. Sellers, JR., Camden, SC (US); Michelle E. Ziolkowski, Troy, OH (US)

(21) Appl. No.: 14/981,138

(22) Filed: Dec. 28, 2015

(51) Int. Cl. G06Q 20/14; G06F 17/30

(52) U.S. Cl. CPC G06Q 20/14; G06F 17/30864

(57) ABSTRACT

Systems and methods for reporting invoice payments are disclosed. A financial institution computing system includes a data storage system, a network interface circuit enabling the financial institution computing system to exchange information over a network, an invoice circuit, an optimization circuit, and a transaction circuit. The invoice circuit receives invoice information from the network, which the optimization circuit uses to determine an optimized payment date and an optimized payment vehicle. The transaction circuit executes the optimized payment vehicle on the optimized payment date, and reports the invoice payment to at least one customer.

### BACKGROUND

Financial institution customers often have several types of accounts and payment methods available to them. Such accounts and payment methods can include electronic payments such as wire transfers and automated clearing house (“ACH”) transactions, paper checks, credit card accounts, checking accounts, and so on. Each of these payment methods may also include various transaction costs, maintenance fees, discounts, revenue sharing programs, and the like, some of which may be specific to certain payment methods while others are shared among other payment methods. The terms of these costs and programs may change over time. Further, some methods of payments may be limited by value, for example by a credit limit, a loan limit, or an account balance. As such, some forms of payment may be preferable to use over others, in terms of transaction costs, timing, and availability. Further, the use of various payment methods and accounts can affect the financial status of a given customer by decreasing assets, increasing or decreasing liabilities, and so on.

Merchants may provide customers with invoices detailing amounts owed and payment due dates for goods or services provided. Invoices may also include various terms, such as terms relating to late fees and interest, discounts for early payment, and so on. Individual customers and merchants may also be restricted to certain forms of payment, for example, a customer may be able to make invoice payments via credit cards and ACH, while a corresponding merchant can only accept payments via paper checks. As such, a customer may be restricted to a suboptimal method of payments.

### SUMMARY

One example embodiment relates to a financial institution computing system. The system includes a data storage system, a network interface circuit, an invoice circuit, an optimization circuit, and a transaction circuit. The data storage system includes a merchant database structured to retrievably store information relating to at least one merchant and an accounts database structured to store information relating to at least one customer. The network interface circuit is structured to enable the financial institution computing system to exchange information over a network. The invoice circuit includes an invoice processing circuit structured to collect invoice information from the network interface circuit. The optimization circuit is structured to receive invoice information from the invoice circuit and includes a scheduling circuit structured to determine at least one optimized payment date based on the invoice information and information in the data storage system. The optimization circuit further includes a transaction cost circuit structured to determine an optimized payment vehicle including a method of payment based on the invoice information and information in the data storage system. The transaction circuit is structured to receive the optimized payment date and the optimized payment vehicle from the optimization circuit and includes a payment transaction circuit structured to execute the optimized payment vehicle on one of the at least one optimized payment date. The transaction circuit further includes a reporting circuit structured to provide the at least one customer a report regarding the optimized payment vehicle.

Another example embodiment relates to a method of reporting invoice payments, as performed by a financial institution computing system. The method includes receiving, by an invoice circuit, invoice information from a network interface circuit. The method further includes determining, by a scheduling circuit of an optimization circuit, at least one optimized payment date based on the invoice information and information stored in a data storage system. The method includes determining, by a transaction cost circuit of the optimization circuit, an optimized payment vehicle including a method of payment based on the invoice information and information stored in the data storage system. The method further includes executing, by a payment transaction circuit of a transaction circuit, the optimized payment vehicle on one of the at least one optimized payment date. The method includes providing, by a reporting circuit of the transaction circuit, at least one customer a report regarding the optimized payment vehicle.

### BRIEF DESCRIPTION OF THE DRAWINGS

FIG. 1 is a block diagram illustrating a payment transaction system, according to an example embodiment.

FIGS. 2A-2C are block diagrams illustrating additional features of the payment transaction system shown in FIG. 1.

FIG. 3 is a flowchart of a method of configuring and executing payment transactions, according to an example embodiment.

### DETAILED DESCRIPTION

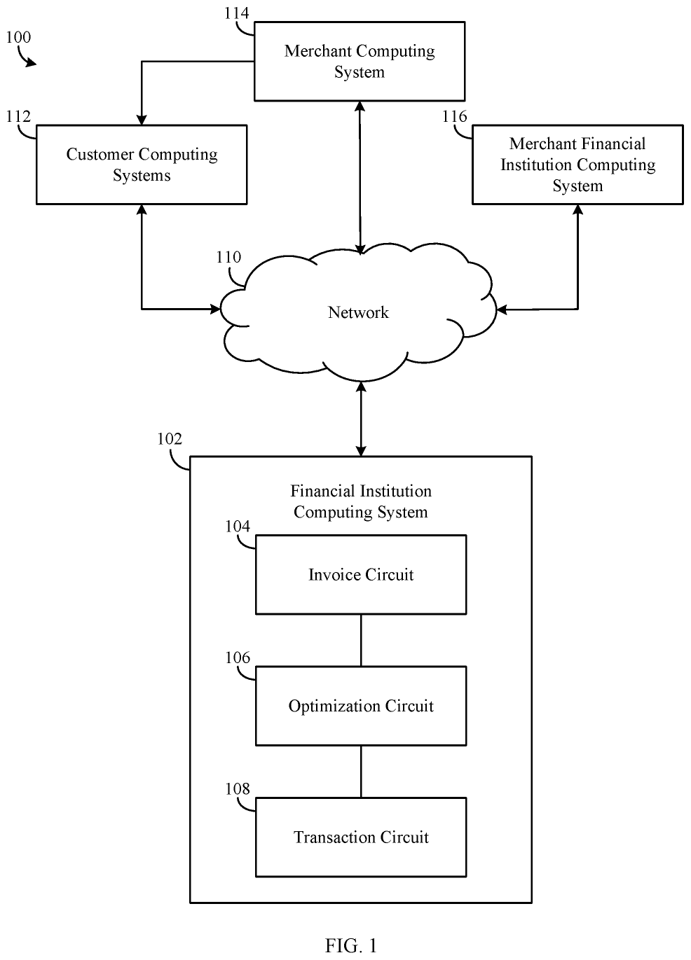

Referring to FIG. 1, a payment transaction system 100 includes a financial institution computing system 102. The financial institution computing system 102 is a computing system at a financial institution that is capable of maintaining customer accounts and processing invoices and associated payment transactions. In the context of the present disclosure, the financial institution can include commercial or private banks, credit unions, investment brokerages, and so on. As will be shown in the discussion that follows, the financial institution computing system 102 enables customers to be apprised of their financial status (e.g., assets, extent of liabilities, active accounts, etc.) in view of pending and recently satisfied vendor invoices. The financial institution computing system 102 may be configured to receive a given invoice, determine an optimized invoice payment vehicle to satisfy the invoice, inform the customer as to how the optimized invoice payment vehicle will affect the assets and liabilities of the customer, and execute the optimized invoice payment vehicle to satisfy the invoice. As the financial institution computing system 102 generally satisfies invoices through the best transactions available to the customer, the financial impact of satisfying one or more vendor invoices may be accurately determined and reliably provided to the customer. Further, the financial institution computing system 102 may be configured to communicate with the customer via multiple different customer devices in the event that one or more customer devices is inaccessible when an important alert or report is to be provided.

The financial institution computing system 102 includes an invoice circuit 104, an optimization circuit 106, and a transaction circuit 108. In an example embodiment, the invoice circuit 104, the optimization circuit 106, and the transaction circuit 108 are implemented in one or more servers comprising processor(s) that execute instructions. Thus, each “circuit” as discussed herein may include one or more processors communicatively coupled to a non-transient memory, and may be constructed in a manner sufficient to perform at least the operations described herein.

The invoice circuit 104 receives invoice information from merchant invoices. Merchant invoices are billing statements from providers of goods and/or services, which may be issued to customers of the financial institution. An invoice can include, for example, an identification of a merchant and a customer (e.g., names and merchant-specific account numbers), itemizations of goods and/or services provided, prices and totals, and payment terms. The invoice may also correspond to one or more purchases involving goods and/or services requested by the customer. In some arrangements, the invoice circuit 104 may compare a received invoice with one or more corresponding purchase orders to approve the invoice (e.g., by determining that all goods and/or services itemized in the invoice was requested by the customer).

In some arrangements, payment terms include a payment due date, and an early payment discount offer. The early payment discount offer provides a customer with an option to pay a discounted invoice amount within a shortened time period. For example, a merchant may offer an early payment discount of 2% 10 net 30, where the customer can pay off the invoice at a 2% discount if paid within ten days of the invoice date, but will have to pay the full invoice price after ten days and up to thirty days after the invoice date. In some arrangements, the invoice circuit 104 can be configured to store or retrieve invoice information relating to specific merchants, such as standard payment terms, accepted payment types, purchase orders, and the like. Upon collecting information relating to a given invoice, invoice circuit 104 forwards that information on to the optimization circuit 106.

The optimization circuit 106 is configured to assemble payment transactions in a manner that satisfies invoices with the most efficient use of customer capital. In one aspect, the optimization circuit 106 may be configured to determine which available payment methods (e.g., paper checks, wire transfers, ACH, credit cards, etc.) would entail the lowest transaction costs (e.g., transaction fees, interest, opportunity costs, etc., while considering which payment methods are accepted by a given merchant). In another aspect, the optimization circuit 106 may be configured to determine which payment dates would allow the customer to satisfy the invoice with the least amount of funds (e.g., in light of any early payment discounts or credit card revenue share programs). In some arrangements, the optimization circuit 106 may be configured to communicate with a given merchant to offer early payment in exchange for a discount or to accept an already established fair approximation of the early payment discount (e.g., where an early payment discount window has passed, or where no early payment discount was offered by the merchant). Upon assembling an optimized payment transaction with at least one low cost payment method and at least one low cost payment date, the optimization circuit 106 forwards such optimized payment transaction information to the transaction circuit 108.

The transaction circuit 108 is configured to execute and report the optimized payment transaction assembled by the optimization circuit 106. The transaction circuit 108 may be configured to execute the payment transaction on one of the payment dates produced by the optimization circuit 106. The transaction circuit 108 may also be configured to complete transfers of customer funds via one or more payment methods, based on the analysis of the optimization circuit 106. The transaction circuit 108 is also configured to inform a customer as to the effect the optimized payment transaction had or will have on the accounts of the customer. Further, in some arrangements, the transaction circuit 108 may be configured to inform the customer as to additional payment methods that would have provided additional cost savings, and offer to set up those additional payment methods for future transactions.

The system 100 further includes a network 110 communicatively interconnecting the financial institution computing system 102 with customer computing systems 112, a merchant computing system 114, and a merchant financial institution computing system 116. The network 110 is a data exchange medium, and may include wireless networks (e.g., cellular networks, Bluetooth®, WiFi, Zigbee®, etc.), wired networks (e.g., Ethernet, DSL, cable, fiber-based, etc.), or a combination thereof. In some arrangements, the network 110 includes the internet. The network 110 allows the computing systems of the system 100 to exchange data with one another.

The customer computing systems 112 include computing systems associated with a customer maintaining at least one account at the financial institution computing system 102. Examples of the customer computing systems 112 include desktop computers, laptop computers, tablets, mobile devices such as smartphones, and so on. The customer computing systems 112 include input and output (“I/O”) devices configured to enable a customer to exchange information with the customer computing systems 112. The input aspect of the I/O device may include any of a keyboard, a touchscreen, a mouse, a microphone, and so on. In turn, the output aspect of the I/O device may include a display, a speaker, one or more illuminating icons or indicators, a vibrating element, and so on. In various arrangements, one or more of the customer computing systems 112 may be configured to convert hard copy invoices into digital files (e.g., where the I/O device is capable of scanning and converting paper documents to .pdf).

In some arrangements, various different devices of the customer computing systems 112 may access various forms of the network 110. For example, in one arrangement, the customer computing systems 112 include a desktop computer communicatively coupled to the internet via a cable-based WiFi network, and a smartphone communicatively coupled to the internet via a cellular-based data network. As such, a customer may be able to receive data from the network 110 while in transit via the smartphone, and may later be able to receive data from the network 110 while at an office with the desktop computer. In addition, if one of the customer computing systems 112 is disabled (e.g., a smartphone battery is depleted) or is otherwise unable to access the network 110 (e.g., a customer office loses electrical power), the customer may still yet be accessible via another one of the customer computing systems 112.

The merchant computing system 114 is also a computing system, but is associated with a merchant providing goods or services to the customer. The merchant computing system 114 may be configured to allow the merchant to generate, maintain, and track customer invoices for goods and/or services provided. The merchant computing system 114 may also be configured to transmit invoices to the customer associated with the customer computing systems 112 (e.g., via the network 110, via hard copy mailed documents, etc.).

The merchant financial institution computing system 116 is associated with a financial institution maintaining one or more financial accounts for the merchant associated with the merchant computing system 114. The merchant financial institution computing system 116 may be configured to receive and process payment transactions generated by the financial institution computing system 102 to satisfy one or more merchant invoices.

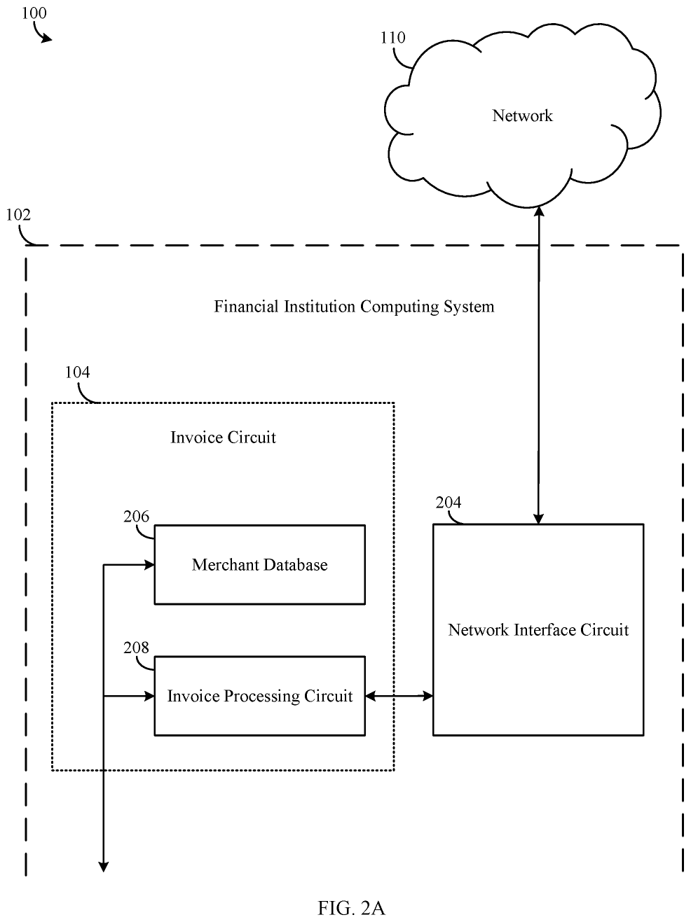

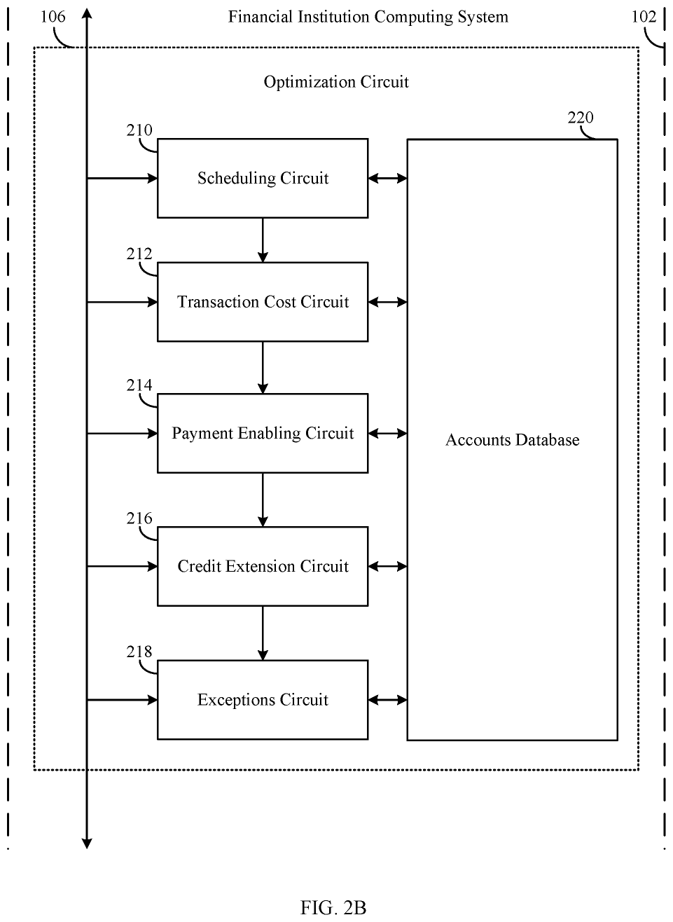

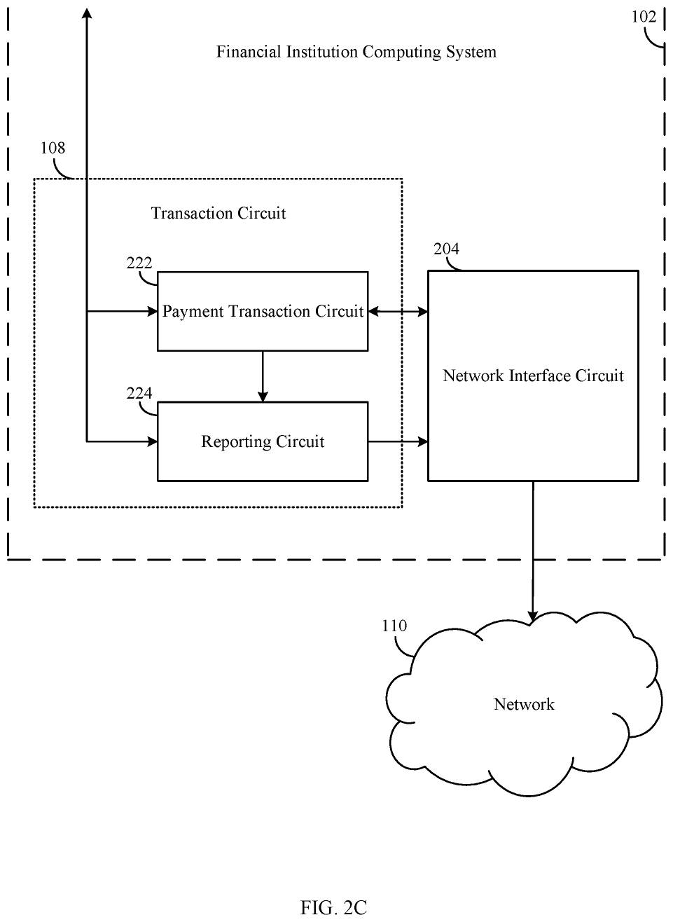

In operation according to one arrangement, a customer may use one of the customer computing systems 112 to request goods and/or services from a merchant (e.g., over the network 110). In some arrangements, the customer computing system 112 may generate a corresponding purchase order. The merchant may receive the purchase order at the merchant computing system 114, render corresponding goods and/or services to the customer, and then use the merchant computing system 114 to provide the customer with an invoice (e.g., over the network 110). The customer may receive the invoice at the customer computing systems 112, and forward the invoice to the financial institution computing system 102. Further, in some arrangements, the customer may forward corresponding purchase orders to the financial institution computing system 102. The financial institution computing system 102 may extract related invoice data from the invoice, approve the invoice in view of one or more purchase orders, determine an optimized invoice payment vehicle, and execute a corresponding transaction. The financial institution computing system 102 may communicate with the merchant financial institution computing system 116 over the network 110 to complete the corresponding transaction, at which point the invoice may be satisfied. The financial institution computing system 102 may further send a report or an alert to one or more of the customer computing systems 112 detailing the optimized invoice payment vehicle used, including any changes in customer balances, liabilities, and so on. Additional functions, features, and details of the system 100 are discussed with respect to FIGS. 2A-2C, below.

Referring now to FIG. 2A, the invoice circuit 104 includes a merchant database 206 and an invoice processing circuit 208. A network interface circuit 204 enables the invoice circuit 104 and various other circuits of the financial institution computing system 102 to exchange data over the network 110. The merchant database 206 is a data storage device, which may include any of several non-transient data storage systems (e.g., flash or disc-based storage media, and/or local or remote data storage servers). The merchant database 206 stores information relating to merchants and merchant invoices. For example, the merchant database 206 may include information relating to each of a plurality of merchants, including accepted payment types, historical or standard discounts, previous invoices, and so on.

The invoice processing circuit 208 is configured to receive invoice information from a customer of the financial institution, and collect information relevant to optimizing a corresponding payment transaction. In one arrangement, the customer provides an invoice to the financial institution computing system 102 over the network 110 as an invoice file. The invoice file may be received at the network interface circuit 204, which can forward the invoice file on to the invoice processing circuit 208. In some arrangements, the invoice file is a digital file wherein invoice information was entered by the customer (e.g., merchant name, due date, amount due, discount information, etc. were entered into respective fields of a financial institution graphical interface disposed on a customer computing device). In other arrangements, the invoice file is a digital scan of a hard copy invoice (e.g., a .pdf file). In such an arrangement, the invoice processing circuit 208 may be configured to extract invoice information from the invoice file (e.g., via data entry, OCR or other text recognition technology).

In some arrangements, the invoice processing circuit 208 can parse out invoice information from the invoice file and store the invoice information in the merchant database 206. Further, the invoice processing circuit 208 may be configured to search the merchant database 206 for information to supplement the invoice file (e.g., merchant discounts, payment methods accepted by the merchant, etc., if missing from the invoice file).

Referring now to FIG. 2B, the optimization circuit 106 includes a scheduling circuit 210, a transaction cost circuit 212, a payment enabling circuit 214, a credit extension circuit 216, an exceptions circuit 218, and an accounts database 220. The accounts database 220 is a data storage system (e.g., similar to the merchant database 206) configured to store customer account information. For example, for a given customer, the accounts database 220 may include information relating to financial accounts of that customer (e.g., checking accounts, savings accounts, credit card limits, lines of credit, etc.). The accounts database 220 may also include information relating to upcoming or pending payments and deposits (e.g., information relating to upcoming or anticipated deposits, deposit and/or balance projections, etc.), including due dates associated with the financial institution (e.g., credit card payment dates, loan payment dates, etc.). Further, in some arrangements, the accounts database 220 stores purchase order information for customers of the financial institution. In some arrangements, the accounts database 220 is maintained on the same data storage system as the merchant database 206.

The scheduling circuit 210 may be configured to determine an optimized invoice payment date in the context of customer information in the accounts database 220 and the invoice information provided by the invoice circuit 104. The optimized invoice payment date may be one or more dates within a date range on which an invoice may be satisfied with the least amount of customer capital (e.g., at the lowest cost). In some arrangements, the date range includes a time period between a current date and an invoice due date. In some such arrangements, the optimized invoice payment date is a date within the date range that is prior to an expiration date of an early payment discount. For example, the scheduling circuit 210 may be configured to first compare the payment due date of the invoice to a current date. Where the payment due date has already elapsed and the invoice includes a late fee, either one that accrues daily or a fixed percentage or amount, the scheduling circuit 210 may be configured to consider the soonest practicable payment date to be the optimized invoice payment date. Under such circumstances, no early payment discount would be available, and late fees may be assessed and compounded with time.

Where the invoice due date has not yet passed, the scheduling circuit 210 may be configured to consider a full date range from the current date to the due date in determining the optimized invoice payment date. In some arrangements, the scheduling circuit 210 uses invoice information provided by the invoice processing circuit 208 (e.g., as provided in an invoice file, with or without supplementation from the merchant database 206) and customer information in the accounts database 220 to identify the optimized invoice payment date. Further, in some arrangements, the scheduling circuit 210 may be configured to consider or limit its analysis to payment vehicles provided by the transaction cost circuit 212 (e.g., in the manner discussed below).

For example, the scheduling circuit 210 may determine a discount window (i.e., a date range spanning the current date and the early payment discount expiration date) based on an early payment discount offered in a given invoice, and use the discount window as a baseline set of optimized invoice payment dates. The scheduling circuit 210 may also consider information in the accounts database 220 relating to scheduled or anticipated upcoming debits and deposits into customer accounts, promotions relating to specific accounts (e.g., revenue sharing programs being applicable on certain dates but not being applicable on other dates), and so on. As such, for example, the scheduling circuit 210 may identify a date that is within the discount window, on which a given account will have sufficient funds to satisfy the invoice (i.e., without being in danger of then or subsequently over-drafting that account), and on which a revenue sharing program for that account will apply.

In addition, in some arrangements, the scheduling circuit 210 is configured to send offers to pay an invoice early at a discount to the corresponding merchant. For example, where a discount window has already passed or where a merchant did not offer an early payment discount, the scheduling circuit 210 may be configured to transmit an early payment offer to the merchant. In some arrangements, the early payment offer includes a proposed payment date prior to the invoice due date and a proposed discounted invoice amount. The scheduling circuit 210 may transmit the early payment offers to merchant computing systems over the network 110 via the network interface circuit 204. In some arrangements, the scheduling circuit 210 is configured to periodically send updated early payment offers. In some arrangements, the updated early payment offers are adjusted to account for the approaching invoice deadline (e.g., offering decreasing discount amounts as the invoice deadline approaches). If the merchant approves a given early payment offer, the scheduling circuit 210 may update one or more optimized payment dates to reflect the approved early payment offer.

The transaction cost circuit 212 is configured to determine an optimized invoice payment vehicle in the context of customer information in the accounts database 220 and the invoice information provided by the invoice circuit 104. The optimized invoice payment vehicle is one or more methods of payment that make up the most capital-efficient way to satisfy a given invoice. In some arrangements, the transaction cost circuit 212 is configured to consider or limit its analysis to payment methods available on dates identified as optimized invoice payment dates by the scheduling circuit 210. Further, in some arrangements, the transaction cost circuit 212 is configured to consider or limit its analysis to payment methods that are accepted by the merchant (e.g., as provided by the invoice processing circuit 208).

In some arrangements, the transaction circuit 108 includes the payment enabling circuit 214. The payment enabling circuit 214 is configured to attempt to enable additional methods of payment for a given merchant based on the optimized invoice payment vehicle determined by the transaction cost circuit 212. In some arrangements, the transaction cost circuit 212 is configured to identify payment methods that, while not yet set up or used by the merchant, would be able to satisfy a given invoice with a lower amount of customer capital compared to the methods of payment accepted by the merchant. In some such arrangements, the payment enabling circuit 214 will attempt to enable those payment methods before the invoice is satisfied. The transaction cost circuit 212 may be configured to generate an alternative or contingent invoice payment vehicle in case the payment enabling circuit 214 is not able to enable any or all of the additional methods of payment identified in the optimized invoice payment vehicle.

For example, the financial institution associated with the financial institution computing system 102 may be configured to complete electronic payment transactions (e.g., person-to-person payment transactions, ACH, or the like). In some arrangements, electronic payment transactions require participating entities (e.g., a customer and a merchant) to complete a registration process (e.g., providing contact or billing information, account information, consent, etc.). As such, in some arrangements, where a given customer is registered for electronic payment transactions (e.g., as indicated by corresponding customer information in the accounts database 220), and where the transaction cost circuit 212 determines that an electronic payment transaction would be the most capital-efficient way to satisfy an invoice, the payment enabling circuit 214 may be configured to attempt to register the merchant for electronic payment transactions.

In one such arrangement, the payment enabling circuit 214 transmits a new payment method request (e.g., an email, an automated phone call, etc.) to the merchant seeking to register the merchant for electronic payment transactions. The registration request may include information relating to an invoice being processed at the financial institution computing system 102. If the payment enabling circuit 214 receives a new payment method approval from the merchant, the payment enabling circuit 214 may use the new payment method as the optimized invoice payment vehicle. The new payment method approval may also be stored in the merchant database 206 for future invoice processing.

In some arrangements, the optimization circuit 106 includes the credit extension circuit 216. The credit extension circuit 216 may be configured to consider new or increased lines of credit in assembling the optimized invoice payment vehicle. The credit extension circuit 216 may open a new line of credit or increase an existing line of credit where the credit terms are more favorable than one or more payment methods available to the customer (e.g., as determined by the transaction cost circuit 212). For example, where a zero or nominal percent interest loan is available (e.g., as a promotion or limited time offer), the credit extension circuit 216 may determine that taking advantage of the loan would be a more efficient use of customer capital than paying off the invoice with cash. In some such arrangements, the customer may provide the credit extension circuit 216 with an approval to open or increase a line of credit (e.g., within specified parameters) in advance. In addition, the credit extension circuit 216 may be configured to apply a line of credit to cover a remaining invoice balance where available account funds will not satisfy the invoice.

In some arrangements, the optimization circuit 106 includes the exceptions circuit 218. The exceptions circuit 218 may be configured to seek an approval of the customer before allowing an optimized payment transaction to occur when some triggering criteria is met. For example, the exceptions circuit 218 may be configured to transmit a notice to a customer device over the network 110 via the network interface circuit 204. The notice may provide the customer with information relating to the optimized payment vehicle and the optimized payment date, along with details relating to the analysis resulting in the optimized payment vehicle and the optimized payment date (e.g., transaction costs, discount amounts and windows, etc.). The notice may further request an authorization of the customer to proceed with the transaction as presented. Alternatively, the notice may be configured to allow the customer to adjust one or more of the terms of the optimized payment vehicle and the optimized payment date (e.g., delaying the payment date, selecting a different account, etc.).

In some arrangements, the notice provided by the exceptions circuit 218 is triggered when a payment transaction involves an amount of customer funds above some maximum threshold (e.g., transactions involving more than $100,000.00, transactions for a sum greater than the amount of funds available to a given method of payment, etc.). In some such arrangements, the maximum threshold is a pre-set default value that is stored in the accounts database 220 (e.g., is pre-set as a standard threshold across all customers). In other such arrangements, the maximum threshold is a value defined by a corresponding customer and stored in the accounts database 220.

Referring now to FIG. 2C, the optimized invoice payment date and the optimized invoice payment vehicle generated by the optimization circuit 106 is received at the transaction circuit 108. The transaction circuit 108 includes a payment transaction circuit 222 and a reporting circuit 224.

The payment transaction circuit 222 is configured to execute the optimized invoice payment vehicle assembled by the transaction cost circuit 212 on the optimized invoice payment date determined by the scheduling circuit 210. For example, where the optimized invoice payment vehicle is a charge card, the payment transaction circuit 222 may debit a sum of funds from a charge card account, and transfer those funds to an account associated with the merchant (e.g., at the merchant financial institution computing system 116). As another example, where the optimized invoice payment vehicle is a paper check, the payment transaction circuit 222 may authorize a paper check drafted against a customer checking account to issue to a remittance address associated with the merchant. Consistent across these and other arrangements, the payment transaction circuit 222 causes an optimized invoice payment vehicle to provide a payment sufficient to satisfy a merchant invoice or balance

The reporting circuit 224 may receive information from one or more of the various circuits of the optimization circuit 106 (e.g., 210, 212, 214, 216, 218, including information from the accounts database 220) and/or the other circuits of the transaction circuit 108 (e.g., 222) to provide a report to the customer computing systems 112. In various arrangements, the report is a communication relating to the optimized invoice payment vehicle and the financial status (e.g., account balances, changes in debts or lines of credit, etc.) of the customer. The scope and content of the report may vary across arrangements, for example ranging from a concise alert including a payment date and an invoice identifier (e.g., a pop-up notification, a push notification on a smartphone, etc.), to a more extensive financial report or a link thereto (e.g., a universal reference locator corresponding to a report webpage or dashboard, an email report, a hard copy report, etc.) detailing the optimized invoice payment vehicle and how it affects the financial status of the customer. The report may reflect the current financial status of the customer and/or the projected financial status of the customer once the optimized invoice payment vehicle is executed. As such, the reporting circuit 224 may apprise a customer of how one or more invoices have or will affect the financial status of the customer.

The reporting circuit 224 may be configured to transmit the report to the customer computing systems 112 over the network 110 via the network interface circuit 204. In some arrangements, the reporting circuit 224 may be configured to transmit reports to select ones of the customer computing systems 112. For example, where the optimized invoice payment vehicle includes an imminent payment date, and/or includes a significant amount of funds, the reporting circuit 224 may transmit the report to a customer mobile device (e.g., an SMS message over a cellular network) so that the customer may be immediately provided with the report. Alternatively, where the optimized invoice payment vehicle includes a modest payment and/or a distant payment date, the reporting circuit 224 may transmit the report as an email to a desktop computing system, allowing the customer to access the report at the convenience of the customer. In addition, the reporting circuit 224 may be configured to transmit reports at various frequencies, for example immediately upon configuring the optimized invoice payment vehicle (e.g., where the payment date is imminent) or periodically as part of a weekly or monthly report (e.g., for routine and/or low value invoices). In some arrangements, the customer may select one or more preferences relating to the operation of the reporting circuit 224 (e.g., always immediate report delivery, always emailed to a specified account, always a specified scope of content, etc.), which may be stored in the accounts database 220.

In operation according to one arrangement, the invoice processing circuit 208 receives invoice information for a customer purchase as a .pdf file from the network interface circuit 204. The invoice processing circuit 208 extracts relevant invoice data from the .pdf file (e.g., via data keying or OCR) and determines the identity of the merchant, an invoice amount, a payment due date, and an early payment discount of 5% 10 net 60 (i.e., the invoice date being day 0). The invoice processing circuit 208 retrieves methods of payment that are accepted by the merchant, along with the remittance address of the merchant from the merchant database 206. The invoice processing circuit 208 then forwards processed invoice information on to the optimization circuit 106.

The scheduling circuit 210 receives the invoice information and accesses the accounts database 220 to determine an optimized invoice payment date. Where the .pdf file was received on day 0, the scheduling circuit 210 determines that a base range of 0 to 10 days from the current date yields a 5% discount (i.e., the 5% 10 net 60 early payment discount term), and that an active charge card with a 1% cash back feature will have sufficient funds to cover the invoice amount. As such, the optimization circuit 106 determines that optimized invoice payment dates include days 0 through 10, and the optimized invoice payment vehicle includes the active charge card.

The transaction circuit 108 receives the optimized invoice payment date and the optimized invoice payment vehicle from the optimization circuit 106. The payment transaction circuit 222 may complete an invoice payment involving the optimized invoice payment vehicle on one of the optimized payment dates (e.g., any of days 0 through 10). The reporting circuit 224 may access the accounts database 220 to identify one or more of the customer computing systems 112 associated with the customer to contact (e.g., phone numbers for SMS messages, email addresses, etc.). The reporting circuit 224 may then transmit a report that includes an invoice identifier (e.g., specifying the corresponding merchant), the invoice amount, the optimized invoice payment date, and the optimized invoice payment vehicle. The report may further include an overall financial status of the customer, including total assets (i.e., reflecting a decrease taken via the new charge card) and liabilities (i.e., including the increase via the new promotional business loan).

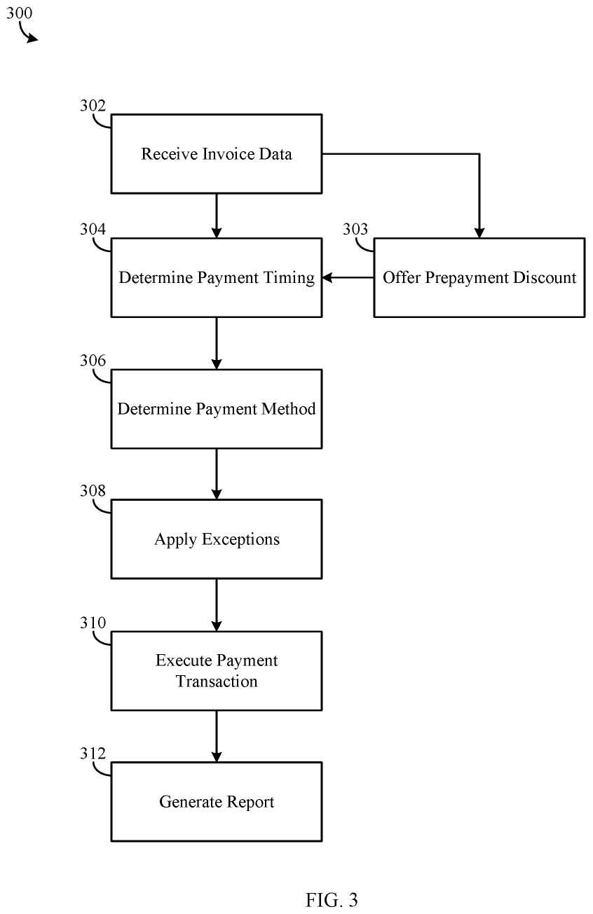

Referring now to FIG. 3, a method 300 of reporting invoice payments is provided. The method 300 is performed by processing and storage hardware at a financial institution computing system (e.g., financial institution computing system 102), as executed by one or more circuits disposed therein that are configured to perform the functions described below.

At 302, invoice information is received. Invoice information is received by an invoice processing circuit (e.g., the invoice processing circuit 208) at an invoice circuit (e.g., the invoice circuit 104). In some arrangements, the invoice information is received from a customer over a network (e.g., the network 110) via a network interface circuit (e.g., the network interface circuit 204). In some arrangements, the invoice information is received as a digital copy of an invoice (e.g., a .pdf copy of an invoice), while in other arrangements, the invoice information is received electronically as an invoice file. In some arrangements, purchase information (e.g., one or more purchase orders) corresponding to the invoice information is received by the invoice processing circuit as well.

In some arrangements, at 303, early payment discounts are offered to merchants. Early payment discounts may be offered by a scheduling circuit (e.g., the scheduling circuit 210) at an optimization circuit (e.g., the optimization circuit 106). The scheduling circuit may send offers to pay an invoice early at a discount to the corresponding merchant, for example where a discount window has already passed or where a merchant did not offer an early payment discount. In some arrangements, the early payment offer includes a proposed payment date prior to the invoice due date and a proposed discounted invoice amount. Further, in some arrangements, the scheduling circuit may periodically send updated early payment offers (e.g., one new early payment offer every week leading up to the invoice deadline).

At 304, an optimized invoice payment date is determined. The optimized invoice payment date may be determined by the scheduling circuit at the optimization circuit. The optimized invoice payment date is determined in the context of customer information in an accounts database (e.g., the accounts database 220) and the invoice information received. The optimized invoice payment date may be one or more dates within a date range on which an invoice may be satisfied with the least amount of customer capital (e.g., based on transaction costs, opportunity costs, revenue sharing programs, etc.). In some arrangements, the date range includes a time period between a current date and an invoice due date. In some such arrangements, the optimized invoice payment date is a date within the date range that is prior to an expiration date of an early payment discount.

At 306, an optimized invoice payment vehicle is determined. The optimized invoice payment vehicle may be determined by a transaction cost circuit (e.g., the transaction cost circuit 212) at the optimization circuit. The optimized invoice payment vehicle is determined in the context of customer information and the invoice information received. The optimized invoice payment vehicle includes one or more methods of payment that provide the most capital-efficient way of satisfying the invoice. In some arrangements, the optimized invoice payment vehicle is limited to those payment methods available on dates identified as optimized invoice payment dates. Further, in some arrangements, the optimized invoice payment vehicle may be limited to those payment methods that are accepted by the merchant (e.g., as provided by the invoice processing circuit 208). However, in other arrangements, the optimized invoice payment vehicle may include one or more methods of payment that are not yet established for the merchant. The transaction cost circuit may also determine a next best optimized invoice payment vehicle if the merchant declines to set up the one or more new methods of payment.

In some arrangements, at 308, exceptions are applied. Exceptions may be applied by an exceptions circuit (e.g., the exceptions circuit 218) at the optimization circuit. An exception triggers a customer authorization procedure before issuing a payment. For example, the exception may be triggered where the value of an invoice or a payment exceeds some set threshold (e.g., as pre-set by a financial institution, or as customized by a given customer). Alternatively, the exception may be triggered where the value of an invoice or a payment exceeds the amount of available funds in a given method of payment (e.g., a method of payment included in the optimized invoice payment vehicle). For example, the exceptions circuit may be configured to transmit a notice to a customer device over a network (e.g., the network 110). The notice may provide the customer with information relating to the optimized invoice payment vehicle and the optimized invoice payment date, along with details relating to the analysis resulting in the optimized invoice payment vehicle and the optimized invoice payment date (e.g., transaction costs, discount amounts and windows, etc.). The notice may further request an authorization of the customer to proceed with the transaction as presented. Alternatively, the notice may be configured to allow the customer to adjust one or more of the terms of the optimized invoice payment vehicle and the optimized invoice payment date (e.g., delaying the payment date, selecting a different account, etc.).

At 310, a payment transaction is executed. The payment transaction may be executed by a payment transaction circuit (e.g., the payment transaction circuit 222) at the transaction circuit 108. A payment transaction is carried out in an optimized manner (e.g., in the manner determined at 306) at an optimized date (e.g., on the date determined at 304). For example, where the optimized invoice payment vehicle is a charge card, the payment transaction circuit may debit a sum of funds from a corresponding charge card account, and transfer those funds to an account associated with the merchant. As another example, where the optimized invoice payment vehicle is an electronic payment, the payment transaction circuit may authorize an ACH transaction transferring funds from a customer checking account to a merchant account. In some arrangements, a payment enabling circuit (e.g., the payment enabling circuit 214) will attempt to activate one or more methods of payment identified in the optimized invoice payment vehicle at the merchant. If the payment enabling circuit is unsuccessful, the payment enabling circuit may apply a next best method of payment, which may also be provided as part of the optimized invoice payment vehicle.

At 312, a report is generated. The report may be generated by a reporting circuit (e.g., the reporting circuit 224) at the transaction circuit. The report may be generated to include information relating to invoice payments that have been optimized by the method 300. For example, the report may include information relating to each invoice payment executed, including invoices, corresponding merchants, and payment amounts. The report may further include information relating to optimized invoice payment vehicles and optimized invoice payment dates, for example, how each vehicle and date was determined. The report may also include information relating to any applicable exceptions, the number, type, and frequency of early payment discount offers made, and so on. Finally, the report may include information relating to the financial status of the customer in view of one or more pending, upcoming, and/or previous optimized invoice payment vehicles.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A financial institution computing system, the system comprising:
a data storage system comprising a merchant database retrievably storing information relating to at least one merchant and an accounts database storing information relating to at least one customer, wherein the merchant database stores payment method information that identifies accepted types of payment methods for the at least one merchant;
a network interface circuit configured to enable the financial institution computing system to exchange information over a network;
an invoice circuit configured to perform optical character recognition on a digital invoice file, comprising extracting an identity of a merchant to be paid from the digital invoice file received via the network interface circuit;
a transaction cost circuit configured to determine an optimized payment vehicle for paying an invoice based on the digital invoice file, wherein a payment method associated with the optimized payment vehicle corresponds to a capital-efficient payment method for satisfying the invoice, the capital-efficient payment method having a lowest transaction cost relative to the accepted types of payment methods for the at least one merchant;
a payment enabling circuit configured to:
determine a payment date corresponding to the capital-efficient payment method;
based on the payment date, select a notification channel from a plurality of computing devices associated with a customer;
transmit to the customer, via one of the plurality of computing devices corresponding to the notification channel selected by the payment enabling circuit based on the payment date, an alert comprising a universal reference locator link; and
in response to receiving, from the one of the plurality of computing devices, an approval indication, perform operations comprising:
compare the payment method associated with the optimized payment vehicle to merchant information stored for the merchant to be paid in the merchant database; and
transmit, to the merchant to be paid and via the network interface circuit, a new payment method request seeking to register the merchant to be paid for the payment method associated with the optimized payment vehicle in response to determining that the payment method associated with the optimized payment vehicle is not included as a type of payment method accepted by the merchant to be paid in the merchant information stored for the merchant in the merchant database; and
a transaction circuit configured to:
when an approval from the merchant is received, then:
update payment method information for the merchant in the merchant database to include the payment method as a payment method accepted by the merchant; and
execute a payment transaction to the merchant using the payment method associated with the optimized payment vehicle; and
when an indication that the merchant that declines the payment method is received, then:
determine a next best optimized payment vehicle acceptable to the merchant, the next best optimized payment vehicle based at least on the lowest transaction cost; and
execute the payment transaction to the merchant using an alternative payment method associated with the next best optimized payment vehicle.

2. (canceled)

3. (canceled)

4. The system of claim 1, wherein the alert is related to a financial status relating to assets and liabilities of the at least one customer.

5. The system of claim 1, further comprising generating a report that includes a financial status relating to assets and liabilities of the at least one customer, and wherein the report is provided after the payment transaction using the optimized payment vehicle is executed.

6. (canceled)

7. (canceled)

8. The system of claim 1, wherein the optimization circuit further comprises a credit extension circuit, the credit extension circuit configured to supplement a customer account associated with the optimized payment vehicle with a line of credit.

9. The system of claim 8, wherein the credit extension circuit is configured to supplement the customer account with the line of credit where at least one method of payment in the optimized payment vehicle does not have sufficient funds to satisfy an invoice.

10. (canceled)

11. The system of claim 1, wherein the exceptions circuit is configured to obtain authorization from the customer after triggering criteria are met.

12. The system of claim 11, wherein the triggering criteria are pre-set by a financial institution associated with the financial institution computing system.

13. The system of claim 11, wherein the triggering criteria are set by the customer.

14. The system of claim 11, wherein the exceptions circuit is configured to receive and incorporate a modification of at least one of the optimized payment vehicle and the optimized payment date from the customer.

15. (canceled)

16. A method of reporting invoice payments as performed by one or more circuits at a financial institution computing system, the method including:
storing, in a data storage system, a merchant database, the merchant databased in including payment method information that identifies accepted types of payment methods for at least one merchant;
receiving, by an invoice circuit, an invoice information via a network interface circuit;
performing, by the invoice circuit, optical character recognition on a digital invoice file, comprising extracting an identify of a merchant to be paid from the digital invoice file received via the network interface circuit;
determining, by a transaction cost circuit of the optimization circuit, an optimized payment vehicle for paying an invoice based on the digital invoice file, wherein a payment method associated with the optimized payment vehicle corresponds to a capital-efficient payment method for satisfying the invoice, the capital-efficient payment method having a lowest transaction cost relative to the accepted types of payment methods for the at least one merchant;
determining a payment date corresponding to the capital-efficient payment method;
based on the payment date, selecting a notification channel from a plurality of computing devices associated with a customer;
transmitting to the customer, via one of the plurality of computing devices corresponding to the notification channel selected by the payment enabling circuit based on the payment date, an alert comprising the universal reference locator link; and
in response to receiving, from the one of the plurality of computing devices, an approval indication, performing operations comprising:
comparing, by a payment enabling circuit, the payment method associated with the optimized payment vehicle to merchant information stored for the merchant to be paid in the merchant database; and
transmitting, by the payment enabling circuit and to the merchant to be paid, a new payment method request seeking to register the merchant for payment method associated with the optimized payment vehicle in response to determining that the payment method associated with the optimized payment vehicle is not included as a type of payment method accepted by the merchant to be paid in the merchant information stored for the merchant in the merchant database;
when an approval from the merchant is received, then:
updating payment method information for the merchant in the merchant database to include the payment method as a payment method accepted by the merchant; and
executing a payment transaction to the merchant using the payment method associated with the optimized payment vehicle; and
when an indication that the merchant that declines the payment method is received, then:
determining a next best optimized payment vehicle acceptable to the merchant, the next best optimized payment vehicle based at least on the lowest transaction cost; and
executing the payment transaction to the merchant using an alternative payment method associated with the next best optimized payment vehicle.

17. (canceled)

18. The method of claim 16, further comprising incorporating, by a credit extension circuit, a line of credit in the optimized payment vehicle.

19-23. (canceled)

24. The system of claim 1, further comprising performing a transaction based on one of an acceptance of the offer, a refusal of the offer, and a failure to respond to the offer by the merchant.

25. A financial institution computing system, the system comprising:
a merchant database retrievably storing invoice payment information relating to at least one merchant, wherein the merchant database stores payment method information that identifies accepted types of payment methods for the at least one merchant;
a network interface circuit configured to enable the financial institution computing system to exchange information over a network;
an invoice circuit configured to:
receive a digital invoice file from the network interface circuit;
parse out invoice information from the digital invoice file using optical character recognition, the invoice information including an identity of a merchant to be paid;
access the merchant database using the network interface circuit;
compare the invoice information from the digital invoice file to invoice payment information for the merchant to be paid stored in the merchant database;
update the invoice payment information stored in the merchant database with invoice information not already stored in the merchant database; and
supplement the invoice information with invoice payment information stored in the merchant database not provided in the digital invoice file;
a transaction cost circuit configured to determine an optimized payment vehicle for paying the invoice based on the supplemented invoice information, wherein a payment method associated with the optimized payment vehicle corresponds to a capital-efficient payment method for satisfying the invoice, the capital-efficient payment method having a lowest transaction cost relative to the accepted types of payment methods for the at least one merchant; and
a payment enabling circuit configured to:
determine a payment date corresponding to the capital-efficient payment method;
based on the payment date, select a notification channel from a plurality of computing devices associated with a customer;
transmit to the customer, via one of the plurality of computing devices corresponding to the notification channel selected by the payment enabling circuit based on the payment date, an alert comprising a universal reference locator link; and
in response to receiving, from the one of the plurality of computing devices, an approval indication, perform operations comprising:
compare the payment method associated with the optimized payment vehicle to merchant information stored for the merchant to be paid in the merchant database;
transmit, to the merchant to be paid and via the network interface circuit, a new payment method request seeking to register the merchant for the payment method associated with the optimized payment vehicle in response to determining that the payment method associated with the optimized payment vehicle is not included as a type of payment method accepted by the merchant to be paid in the merchant information stored for the merchant in the merchant database; and
a transaction circuit configured to
when an approval from the merchant is received, then:
update payment method information for the merchant in the merchant database to include the payment method as a payment method accepted by the merchant; and
execute a payment transaction to the merchant using the payment method associated with the optimized payment vehicle; and
when an indication that the merchant that declines the payment method is received, then:
determine a next best optimized payment vehicle acceptable to the merchant, the next best optimized payment vehicle based at least on the lowest transaction cost; and
execute the payment transaction to the merchant using an alternative payment method associated with the next best optimized payment vehicle.

26. (canceled)

27. (canceled)

28. The system of claim 1, wherein the payment date is determined based on an anticipated discount percentage.
